(19) United States
(12) Patent Application Publication
(10) Pub. No.: US 2013/0332831 A1
(43) Pub. Date: Dec. 12, 2013

(54) CONTENT MANAGEMENT USER INTERFACE THAT IS PERVASIVE ACROSS A USER'S VARIOUS DEVICES

(71) Applicants: Marc Steven Birnkrant, Poway, CA (US); Gary Robert Lyons, San Diego, CA (US); Edward Theodore Winter, San Diego, CA (US); Adrian Crisan, San Diego, CA (US); Christopher Mark Ohren, San Diego, CA (US); Arvind Knudsen, San Diego, CA (US); Andrew Lee Lawton, San Marcos, CA (US)

(72) Inventors: Marc Steven Birnkrant, Poway, CA (US); Gary Robert Lyons, San Diego, CA (US); Edward Theodore Winter, San Diego, CA (US); Adrian Crisan, San Diego, CA (US); Christopher Mark Ohren, San Diego, CA (US); Arvind Knudsen, San Diego, CA (US); Andrew Lee Lawton, San Marcos, CA (US)

(73) Assignee: SONY CORPORATION

(21) Appl. No.: 13/490,864

(22) Filed: Jun. 7, 2012

(51) Int. Cl. G06F 3/048

(52) U.S. Cl. 715/719; 715/838; 715/716

(57) ABSTRACT

A content management user interface (UI) provides a consistent appearance and operation across multiple devices of a user. Thumbnails representing content that is located on the user's devices are presented along with layered filtering operators which enable a user to filter the thumbnails by both content source and content type.

### I. FIELD OF THE INVENTION

The present application relates generally to content management user interfaces (UI) that present a consistent appearance and operation across all of a user's various computerized devices.

### II. BACKGROUND OF THE INVENTION

Computerized device users now accumulate a wide variety of digitized content from many sources. Being able to manage and share such personalized content across multiple devices of the user and with other users in an easy, intuitive way is a desirable but as yet unmet goal.

### SUMMARY OF THE INVENTION

Accordingly, an electronic device includes a display, a processor controlling the display to present demanded images, and a computer readable storage medium accessible to the processor and bearing instructions which when executed by the processor cause the processor to present on the display a user interface (UI) including plural thumbnail images, each of which is associated with an underlying asset. At least some thumbnail images haves a category icon superimposed thereon. The UI also includes filter selector elements to define which thumbnails appear on the display and which are desired not to appear. The filter selector elements include category selector elements, one of which may be selected to define which thumbnail categories are presented on the display, and content source selector elements, one of which may be selected in addition to a selected category selector element to define which thumbnails may be presented based on a source of the respective underlying asset. In this way, multiple filters may be used to winnow which thumbnails are selected for presentation on the display. In other words, an asset associated with multiple folders is locatable by applying overlapping filters afforded by the category and source selector elements.

In some implementations, the category selector elements include an “all” selector element, which when selected causes all categories to be presented on the UI, subject to source filtering. The category selector elements may also include a “new” selector element which when selected causes only thumbnails representing newly added content to be presented on the display, subject to source filtering. Additionally, the category selector elements can include a “pictures” selector element, which when selected causes only thumbnails representing photographs to be presented on the display, subject to source filtering, and a “video” selector element which when selected causes only thumbnails representing videos to be presented on the display, subject to source filtering. Still further, the category selector elements may include a “music” selector element, which when selected causes only thumbnails representing music assets to be presented on the display, subject to source filtering. If desired, the category selector elements can also include an email and/or document selector element which when selected cause only thumbnails associated with emails and/or documents, respectively, to be presented on the display.

On the other hand, the content source selector elements can include a PC icon which when selected causes only thumbnails associated with content on a PC to be presented in the UI and a phone icon which when selected causes only thumbnails associated with content from a phone to be presented in the UI. The content source selector elements can also include a social networking Internet site icon which when selected causes only thumbnails associated with content on a user's social networking page presented in the UI. Moreover, the content source selector elements may include a video source icon which when selected causes only thumbnails associated with content from a video source to be presented in the UI.

In example embodiments thumbnails representing music assets are overlaid with a music icon and thumbnails representing video assets are overlaid with a video icon. In contrast, thumbnails representing photo assets are not overlaid with a category icon in these examples.

In another aspect, a method includes automatically gathering content assets from a user's devices, and associating metadata with at least some assets to act as tags for filtering purposes. The method also includes generating thumbnails for each asset, presenting the thumbnails in a user interface (UI), and filtering thumbnails from appearing in the UI based on signals received from selector elements of the UI.

In another aspect, an apparatus includes a video display presenting a content management user interface (UI) having a consistent appearance and operation across multiple devices of a user. Thumbnails that represent content that is located on the devices are presented on the UI along with layered filtering operators configured to enable a user to filter the thumbnails by both content source and content type.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram showing an example system according to present principles;

FIGS. 2-9 are screen shots showing various configurations of the UI; and

FIG. 10 is a flow chart of example logic according to present principles.

### DETAILED DESCRIPTION OF THE PREFERRED EMBODIMENT

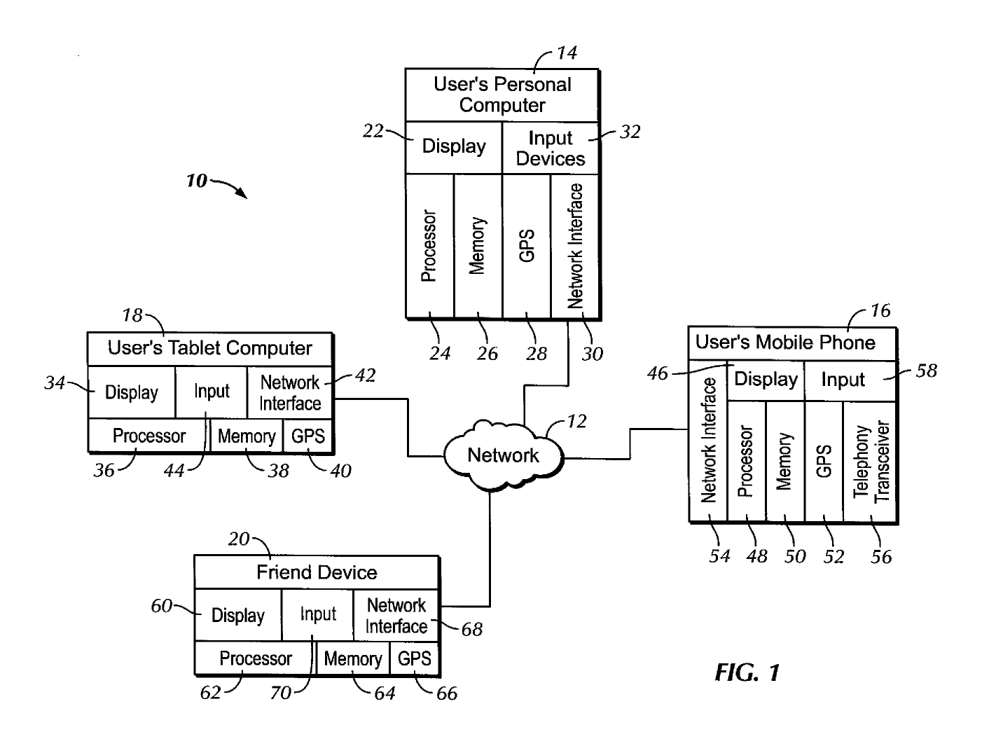

Referring initially to FIG. 1, a system 10 is shown in which multiple user devices communicate in a network 12 such as a home network that may be connected to the Internet. In the example shown, the user devices include a personal computer 14, a mobile telephone 16, and a tablet computer 18. Additional devices such as but not limited to TVs, cameras, disk players, game players, and so on may be provided, without limitation. The home network 12 may also communicate with one or more friend computing devices 20, e.g., with the tablet computers, mobile phones, etc. of people who may be friends of the user of the network 12.

In the example shown, the PC 14 includes a display 22 such as a flat panel standard definition (SD) or high definition (HD) display, which may be a touch screen display, and that is controlled by a processor 24 accessing instructions and data on a computer readable storage medium 26 such as disk-based and/or solid state storage and/or memory gates, etc. to undertake present principles. Geographic position information may be input to the processor by a global positioning satellite system (GPS) receiver 28. The processor may communicate with the network 12 using a network interface 30 such as but not limited to a wired or wireless modern, wireless telephony transceiver, and the like. User commands may be received by the processor from one or more input devices 32 such as mice, keyboards or keypads, telephone key pads, remote commanders (RC), voice recognition software coupled to a microphone, etc.

The tablet computer 18 includes a display 34 such as a flat panel standard definition (SD) or high definition (HD) display, which may be a touch screen display, and that is controlled by a processor 36 accessing instructions and data on a computer readable storage medium 38 such as disk-based and/or solid state storage to undertake present principles. Geographic position information may be input to the processor by a GPS receiver 40. The processor may communicate with the network 12 using a network interface 42 such as but not limited to a wired or wireless modem, wireless telephony transceiver, and the like. User commands may be received by the processor from one or more input devices 44 such as mice, keyboards or keypads, telephone key pads, remote commanders (RC), voice recognition software coupled to a microphone, etc.

The mobile phone 16 includes a display 46 such as a flat panel standard definition (SD) or high definition (HD) display, which may be a touch screen display, and that is controlled by a processor 48 accessing instructions and data on a computer readable storage medium 50 such as disk-based and/or solid state storage to undertake present principles. Geographic position information may be input to the processor by a GPS receiver 52 to, e.g., tag pictures taken by the camera with the location, date and time they were taken. The processor may communicate with the network 12 using a network interface 54 such as but not limited to a wired or wireless modem, wireless telephony transceiver 56, and the like. User commands may be received by the processor from one or more input devices 58 such as mice, keyboards or keypads, telephone key pads, remote commanders (RC), voice recognition software coupled to a microphone, etc.

The friend device 20 includes a display 60 such as a flat panel standard definition (SD) or high definition (HD) display, which may be a touch screen display, and that is controlled by a processor 62 accessing instructions and data on a computer readable storage medium 64 such as disk-based and/or solid state storage to undertake present principles. Geographic position information may be input to the processor by a GPS receiver 66. The processor may communicate with the network 12 using a network interface 68 such as but not limited to a wired or wireless modem, wireless telephony transceiver, and the like. User commands may be received by the processor from one or more input devices 70 such as mice, keyboards or keypads, telephone key pads, remote commanders (RC), voice recognition software coupled to a microphone, etc.

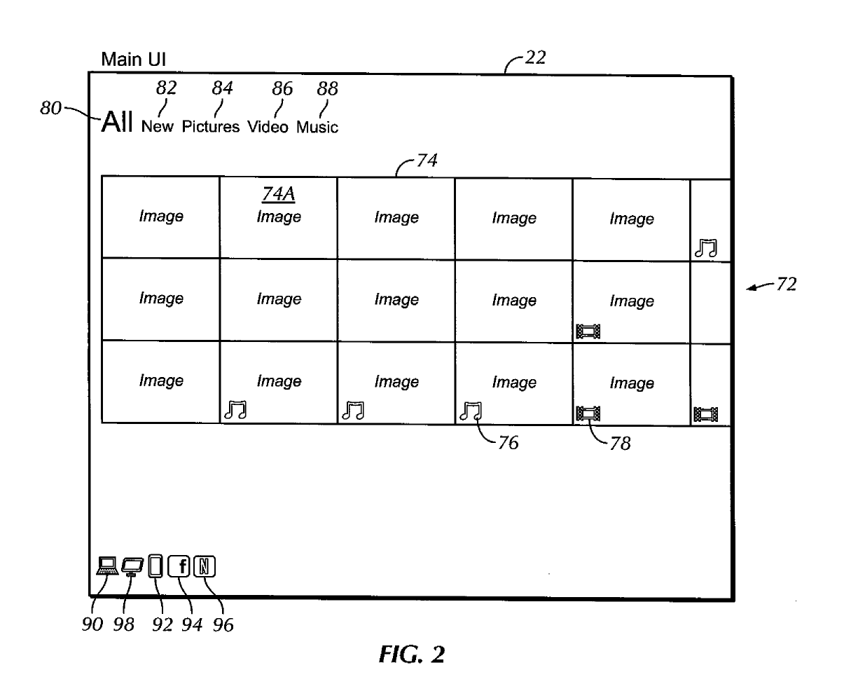

Now turning to FIG. 2, a user interface (UI) 72 is shown that may be presented on any of the displays 22, 34, 46, 60 shown in FIG. 1. As shown, the UI 72 includes plural thumbnail images 74, each of which when selected causes an underlying asset to be presented on the device. In the example shown, the UI 72 includes three rows of thumbnail images, and a user can cause the images to scroll right and left across the screen by appropriately manipulating the input device, which, recall, may be a touch screen feature of the display 22 itself.

In the example shown, thumbnail images representing music assets may have a music icon 76 superimposed thereon. The music icon 76 may appear as musical notes as shown. In contrast, thumbnail images representing video assets may have a video icon 78 superimposed thereon. The video icon 78 may appear as a piece of video film as shown. The icons 76, 78 may appear in the lower left corner of the associated thumbnails. Thumbnails representing photographs, on the other hand, may bear no category icon, such as the thumbnail 74A. Note that while photos, video, and music are represented in FIG. 2, additional categories may also be represented, e.g., email documents, word processing documents, spreadsheet documents, and slide show documents, and these documents likewise may be represented by thumbnails over which are superimposed category icons unique to the particular category to which they pertain.

The UI 72 can also include filter selector elements to define which thumbnails appear on the display and which are desired not to appear. In the example shown, along the upper left border of the display 22 are category selector elements while along the bottom left border of the display 22 are content source selector elements. In this way, multiple filters, e.g., a content filter and a source filter, can be used to winnow which thumbnails are selected for presentation on the display. Stated differently, an asset may be associated with multiple folders and may still be easily located by applying the overlapping filters afforded by the category and source selector elements.

In the specific embodiment shown, the category selector elements include an “all” selector element 80, which when selected causes all categories to be presented on the UI 72, subject to source filtering described below, and a “new” selector element 82 which when selected causes only thumbnails representing newly added content (e.g., within the past week) to be presented, subject to source filtering described below. Also, the category selector elements include a “pictures” selector element 84, which when selected causes only thumbnails representing photographs to be presented, subject to source filtering described below, and a “video” selector element 86 which when selected causes only thumbnails representing videos to be presented, subject to source filtering described below. Further, the category selector elements include a “music” selector element 88, which when selected causes only thumbnails representing music assets to be presented, subject to source filtering described below.

On the other hand, the content source selector elements include a PC icon 90 which when selected causes only thumbnails associated with content on the PC 14 to be presented in the UI 72, subject to any category filtering using the category selector elements discussed above. Similarly, the content source selector elements may include a phone icon 92 which when selected causes only thumbnails associated with content on the phone 16 to be presented in the UI 72 subject to category filtering. Likewise, the content source selector elements may include a social networking Internet site icon 94 which when selected causes only thumbnails associated with content on the user's social networking page (Facebook in the example shown) to be presented in the UI 72 subject to category filtering. Also, the content source selector elements may include a video source icon 96 which when selected causes only thumbnails associated with content from a video source (Netflix in the example shown) to be presented in the UI 72 subject to category filtering. Icons 98 representing other content sources may also be included.

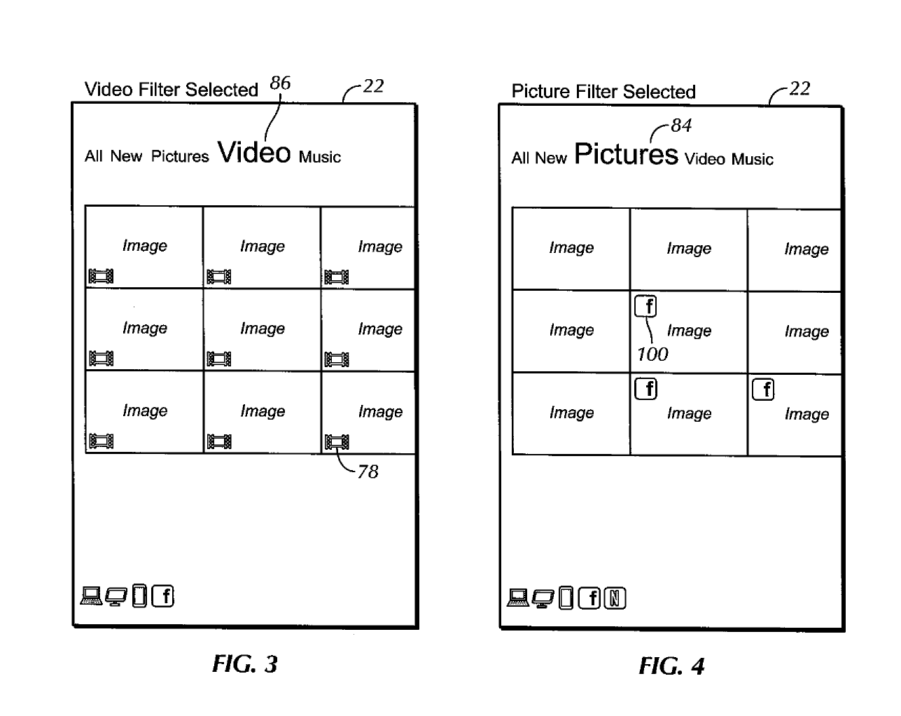

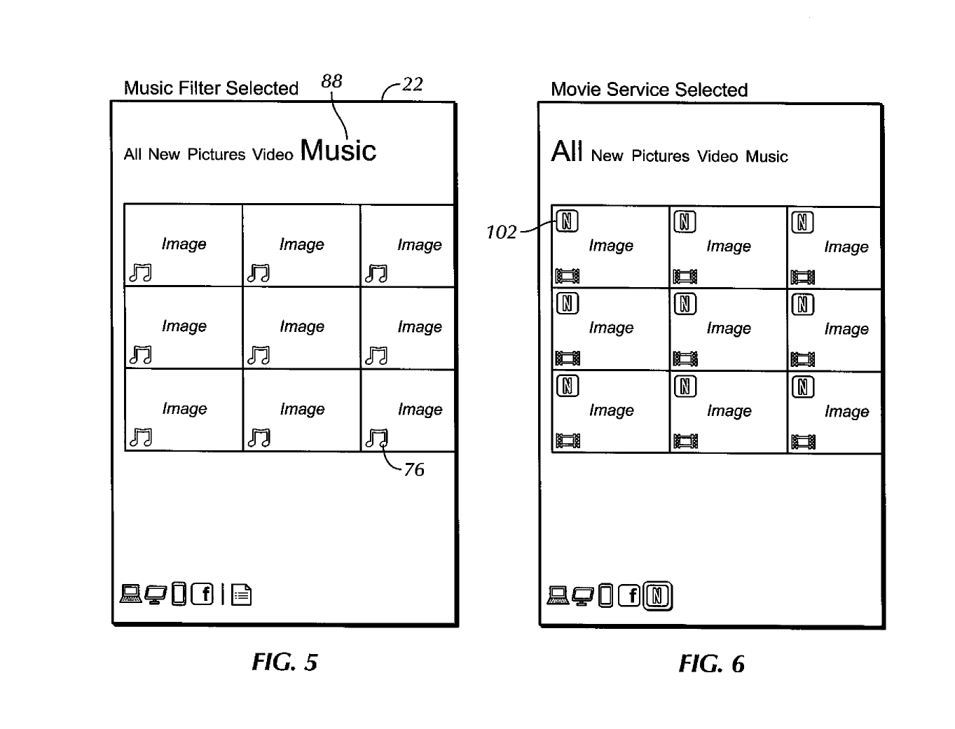

FIGS. 3-9 illustrate various principles discussed above. In FIG. 3, the video category icon 86 has been selected, causing only thumbnails associated with video assets to be presented on the display 22, with the video icon 78 being overlaid on each displayed thumbnail accordingly. In FIG. 4, the pictures category icon 84 has been selected, causing only thumbnails associated with photograph assets to be presented on the display 22, with no category icons being overlaid on any of the thumbnails but with a source icon 100 being superimposed on thumbnails representing content from a particular source, in this case, from the user's social networking site page (Facebook, in the example shown). FIG. 5 shows that the music category icon 88 has been selected, causing only thumbnails associated with music assets to be presented on the display 22, with the music icon 76 being overlaid on each.

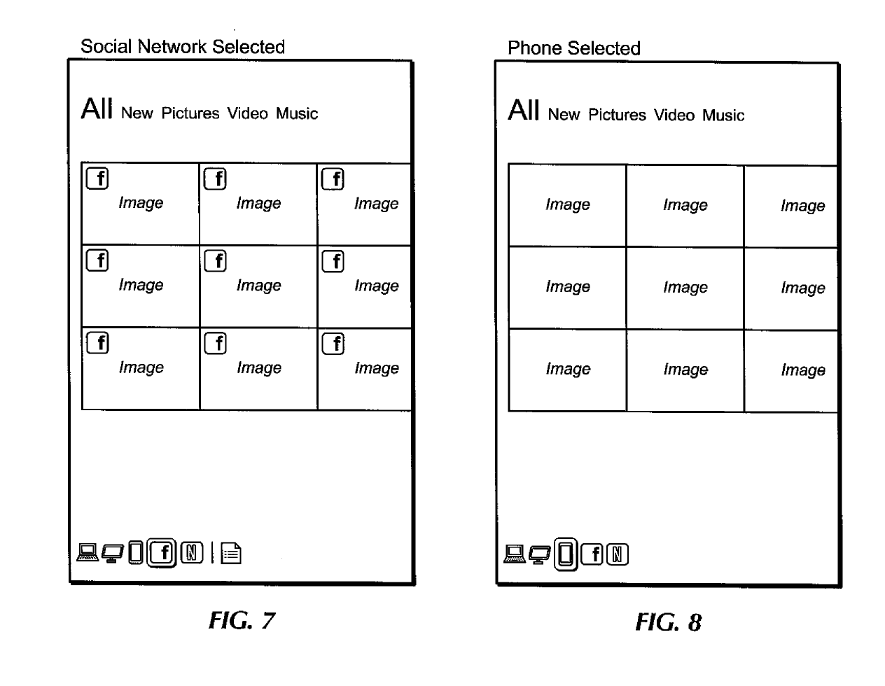

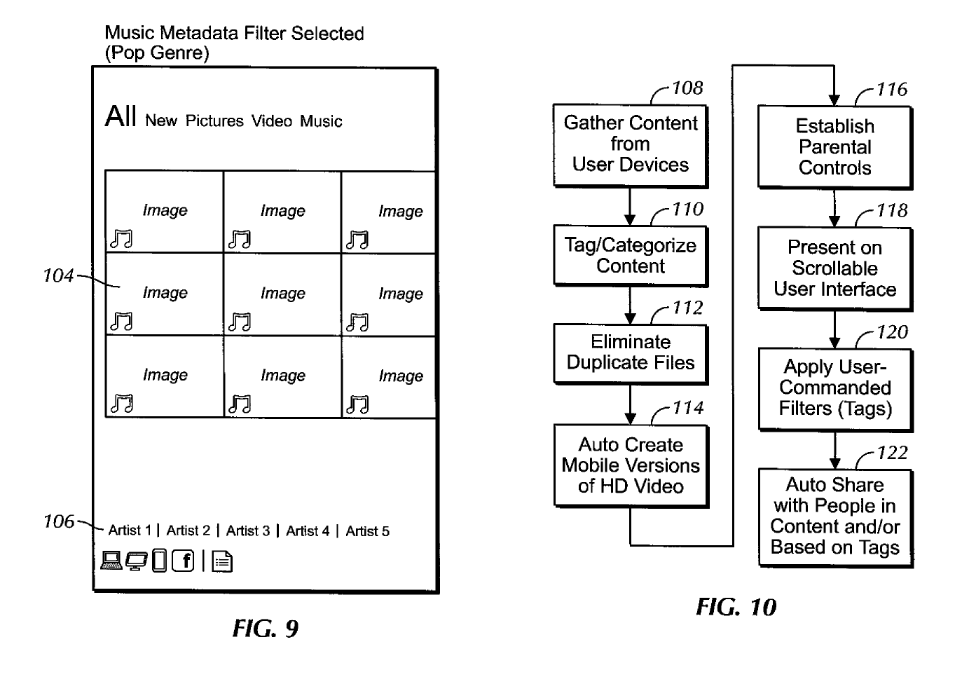

In FIG. 6, the “all” category selector element 80 is selected but the video source icon 96 is selected to cause only thumbnails associated with content from a video source (Netflix in the example shown) to be presented in the UI 72. Correspondingly, source icons 102 are superimposed on thumbnails representing content from the selected source, in this case, from Netflix. FIGS. 7 and 8 illustrate the effects of selecting all content from the social networking site and the mobile phone, respectively in line with the above principles, while FIG. 9 illustrates that hovering a cursor over a thumbnail 104 causes metadata 106 associated with the underlying asset to be presented on the UI 72, which metadata may be selected in turn to cause only thumbnails representing assets conforming to the metadata (by, e.g., matching every element of metadata or some predefined subset thereof) to be presented on the UI 72.

Turning now to FIG. 10, at block 108 content is gathered from the user's devices and, if permission is granted, from friend devices 20 as well. To do this, digital living network architecture (DLNA) principles may be used in which the user devices 14, 16, 18 discover content on the network 12, including metadata associated with the content. The metadata, which can be appended at block 110 to the assets to act as tags for filtering purposes, can include asset type, asset name, date of access/creation/storage, and folder location. The metadata may also include names of people associated with the asset, e.g., names and addresses of people on photographs, geographic and time information associated with the asset, e.g., geographic location and time a picture was taken as indicated by extended display identification data (EDID) information, etc.

Metadata can also be appended to content manually by the user, e.g., the subject of the asset (Jim's birthday, Mary's graduation, Mozart concert) can be added to metadata to describe the asset. This subject tagging may also be executed automatically. For example, the gathering processor, e.g., the PC processor shown in FIG. 1, may access a map application on the Web such as Google Maps to find the names of places near a geographic location indicated by a content generating device's GPS receiver, and if a place name is, for instance, the name of a theater or arena, then access an event database to determine which event was held at that place at the date and time EDID data indicates the asset was generated. If desired, the user may be presented with a prompt asking the user if the discovered place name and event name are correct.

Likewise, facial recognition may be executed on a photograph and then the user's social networking site, and those of his friends, can be accessed to match faces in the photo with faces that may appear on the social networking sites along with names of subjects in the photos. The user may similarly be presented with a prompt asking if a name gleaned next to a matching photo on the social networking site should be added to the metadata of the (matching) photograph being gathered. The same can be executed for video sites which present photos of actors along with their names. Also, content may be automatically gathered by accessing the user's social networking site and video source site and downloading content therefrom.

At block 112 duplicate files are eliminated. Files may be regarded as duplicates of each other if their metadata matches exactly or within a predetermined tolerance, or if image recognition indicates a pixel match exceeding a threshold percentage. If desired, mobile (smaller, SD versions) versions of any HD video assets may be automatically generated at block 114 by, e.g., sending the BD videos through a lower resolution video codec.

Parental controls may be established at block 116 if desired, manually by the user for each asset or automatically by applying rules to image recognition features such as, e.g., bare skin. Thumbnails are then generated for each asset by, e.g., miniaturizing the first frame of a video or an entire photo asset and presented on the scrollable UI 72 at block 118. The thumbnails may be filtered at block 120 using the selector elements described above and matching the selection criteria with the tags that were the subject of block 110. Content may also be automatically shared with friend devices at block 122 by matching recognized faces in the assets with a database of faces and electronic assets gleaned from, e.g., social networking sites as described above and/or manually entered by a user into an address book maintained on a computer readable storage accessible to the executing processor.

While the particular CONTENT MANAGEMENT USER INTERFACE THAT IS PERVASIVE ACROSS A USER'S VARIOUS DEVICES is herein shown and described in detail, it is to be understood that the subject matter which is encompassed by the present invention is limited only by the claims.

What is claimed is:

1. Electronic device, comprising:
display;
processor controlling the display to present demanded images; and
computer readable storage medium accessible to the processor and bearing instructions which when executed by the processor cause the processor to:
present on the display a user interface (UI) including plural thumbnail images, each of which is associated with an underlying asset, at least some thumbnail images having a category icon superimposed thereon;
the UI also including filter selector elements to define which thumbnails appear on the display and which are desired not to appear, the filter selector elements including category selector elements, one of which may be selected to define which thumbnail categories are presented on the display, the filter selector elements also including content source selector elements, one of which may be selected in addition to a selected category selector element to define which thumbnails may be presented based on a source of the respective underlying asset such that multiple filters may be used to winnow which thumbnails are selected for presentation on the display, whereby an asset associated with multiple folders is locatable by applying overlapping filters afforded by the category and source selector elements.

2. The device of claim 1, wherein the category selector elements include an “all” selector element, which when selected causes all categories to be presented on the UI, subject to source filtering.

3. The device of claim 2, wherein the category selector elements include a “new” selector element which when selected causes only thumbnails representing newly added content to be presented on the display, subject to source filtering.

4. The device of claim 2, wherein the category selector elements include a “pictures” selector element, which when selected causes only thumbnails representing photographs to be presented on the display, subject to source filtering, and a “video” selector element which when selected causes only thumbnails representing videos to be presented on the display, subject to source filtering.

5. The device of claim 2, wherein the category selector elements include a “music” selector element, which when selected causes only thumbnails representing music assets to be presented on the display, subject to source filtering.

6. The device of claim 2, wherein the category selector elements include an email and/or document selector element which when selected cause only thumbnails associated with emails and/or documents, respectively, to be presented on the display.

7. The device of claim 2, wherein the content source selector elements include a PC icon which when selected causes only thumbnails associated with content on a PC to be presented in the UI and a phone icon which when selected causes only thumbnails associated with content from a phone to be presented in the UI.

8. The device of claim 7, wherein the content source selector elements include a social networking Internet site icon which when selected causes only thumbnails associated with content on a user's social networking page presented in the UI.

9. The device of claim 7, wherein the content source selector elements include a video source icon which when selected causes only thumbnails associated with content from a video source to be presented in the UI.

10. The device of claim 1, wherein thumbnails representing music assets are overlaid with a music icon.

11. The device of claim 1, wherein thumbnails representing video assets are overlaid with a video icon.

12. The device of claim 1, wherein thumbnails representing photo assets are not overlaid with a category icon.

13. Method comprising:
automatically gathering content assets from a user's devices;
associating metadata with at least some assets to act as tags for filtering purposes;
generating thumbnails for each asset;
presenting the thumbnails in a user interface (UI); and
filtering thumbnails from appearing in the UI based on signals received from selector elements of the UI.

14. The method of claim 13, wherein the tags are used to conform the UI to the signals from the selector elements.

15. The method of claim 13, wherein the processor automatically sends assets to at least one friend device by matching recognized faces in the assets with a database of faces and electronic assets gleaned from Internet sites as described above and/or manually entered by a user into an address book maintained on a computer readable storage accessible to the processor.

16. The method of claim 13, wherein the metadata includes asset type, asset name, date of access/creation/storage, and folder location of the asset.

17. The method of claim 16, wherein the metadata also includes names of people associated with the respective asset.

18. The method of claim 13, wherein the processor generates metadata for an asset by accessing a map application on a network to find names of places near a geographic location indicated by a global positioning satellite (GPS) receiver inputting position information accessible to the processor, and responsive to determining a place name therefrom, the processor accesses an event database to determine which event was held at the place name at a time metadata indicates the asset was generated.

19. The method of claim 18, wherein the processor presents a prompt on the display asking if a discovered place name and event name are correct.

20. Apparatus, comprising:
a video display presenting a content management user interface (UI) having a consistent appearance and operation across multiple devices of a user, thumbnails representing content that is located on the devices being presented on the UI along with layered filtering operators configured to enable a user to filter the thumbnails by both content source and content type.
